(19) United States
(12) Patent Application Publication
(10) Pub. No.: US 2013/0120596 A1
(43) Pub. Date: May 16, 2013

(54) METHOD OF CONFIGURING A WIRELESS NETWORK CAMERA WIRELESSLY

(71) Applicant: Herman Yau, Palo Alto, CA (US)

(72) Inventor: Herman Yau, Palo Alto, CA (US)

(21) Appl. No.: 13/296,796

(22) Filed: Nov. 15, 2011

(51) Int. Cl. H04N 5/225; H04W 84/02

(52) U.S. Cl. 348/207.11; 348/E05.024

(57) ABSTRACT

A wireless camera having a wireless hotspot functionality that can allow a Smartphone to configure the camera. The wireless camera comprises an image sensor, a processor, a memory coupled to the processor, and an RF device, wherein the RF device links to a wireless router connected to the Internet. The RF device is adapted to form a wireless hotspot so a plurality of second devices can connect to the Internet via the wireless camera. The image sensor captures digital images. A second device links to the Internet via the RF device. An input device is also provided for actuating an input to enable a Wi-Fi Setup mode.

### FIELD OF THE INVENTION

The present disclosure is directed to an improved wireless camera. More particularly, the present disclosure is directed to a wireless device that forms a wireless hotspot so a second device may link to the wireless camera and link to a communication network.

### BACKGROUND OF THE RELATED ART

The current way of configuration for a Wi-Fi setup is to connect the camera by network cable into a router. Thereafter, a user may execute a software program on the computer to search for the camera's IP address on the network and then connect the camera at a specific IP address. The user may then enter the configuration information for the Wireless network. The user may then unhook the network cable from the camera and reboot the camera.

The prior art is cumbersome and overly complex, requiring the use of two network adapters (Ethernet and Wi-Fi). In many such implementations, the camera uses one network adapter at a time, meaning that a switch takes place at some point (from Ethernet to Wi-Fi) during the setup process.

This Ethernet to Wi-Fi switch is a major point of failure, as there is no verification of the network (such as internet connectivity) that is done before the device switches over, so the user cannot find the failure until after the switch has happened; at which point there is no recourse but to start the setup process over.

Furthermore, the current approach requires the user to have physical access to the Wi-Fi router and be in close proximity to that Wi-Fi router (within the network cable length), both has its challenges in different installation scenarios.

The inherent complexity in this design also results in more potential failure points. All this added together and you end up with setup process that provides an unfriendly user experience at best and confusion when it breaks down.

### SUMMARY OF THE INVENTION

According to a first aspect of the present disclosure, there is provided a method of linking to a network, comprising: providing a camera that includes an RF device. The method also includes linking the RF device to a wireless router and linking the wireless router to the Internet. The method also includes linking to the RF device to link to the Internet.

According to another aspect, the method also includes capturing digital images from the camera and forming a wireless hotspot so a second device can link to the Internet via the RF device.

According to yet another aspect, the method also includes actuating an input to enable a Wi-Fi Setup mode and forming a wireless network and allowing the RF device to connect wirelessly direct to the RF device from the second device.

According to a further aspect, the method further includes controlling the camera from the second device to control the camera directly and configure settings.

In another aspect, the method further includes the RF device connecting to an existing wireless network and routing an Internet connection to the second device. The method may also include connecting the camera to a network and verifying a network connection. The method also may include conducting an automatic network verification for an integrity of the connected wireless network and performing a diagnostic that includes at least one of internet connectivity, wireless signal strength, network bandwidth and throughput. In another embodiment, the method also includes registering the camera with a remote server.

In another embodiment, the method may include disabling the Wi-Fi Setup mode and the camera serving as a Wi-Fi client. The camera comprises an image sensor. Additionally, the camera captures digital video. The RF device comprises a wireless transmitter and receiver. The method may also include linking a plurality of computer devices to the RF device to connect to a server.

In yet another aspect, there is provided a wireless camera. The wireless camera comprises an image sensor, a processor, a memory coupled to the processor, and an RF device, wherein the RF device links to a wireless router connected to the Internet. The RF device is adapted to form a wireless hotspot so a plurality of second devices can connect to the Internet via the wireless camera. The image sensor captures digital images. A second device links to the Internet via the RF device. An input device is also provided for actuating an input to enable a Wi-Fi Setup mode.

The camera may also include a control for controlling the camera from a second device to control the camera directly and to configure camera settings. The RF device connects to an existing wireless network and routes an Internet connection to the second device. The processor may connect the camera to a network and may verify a network connection. The processor may also conduct automatic network verification for an integrity of the connected wireless network.

The processor may also conduct a diagnostic that includes at least one of Internet connectivity, wireless signal strength, network bandwidth and throughput. The processor may also register the camera with a remote server. The processor may also disable the Wi-Fi Setup mode and the camera may then serving as a Wi-Fi client. The RF device comprises a wireless transmitter and receiver so the plurality of computer devices can link the RF device to connect to a server.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, the drawings are illustrative of certain ways of performing the invention. Others will be readily apparent to those skilled in the art.

FIG. 1 shows a schematic of a system of the present invention with the wireless camera forming a wireless hotspot;

FIG. 2 shows a process flow diagram of a method according to the present invention;

FIG. 3 shows a simplified high level schematic view of a camera according to the present disclosure; and

FIG. 4 shows a method of linking to the camera by a Smartphone according to the present disclosure.

### DETAILED DESCRIPTION OF THE PREFERRED EMBODIMENTS

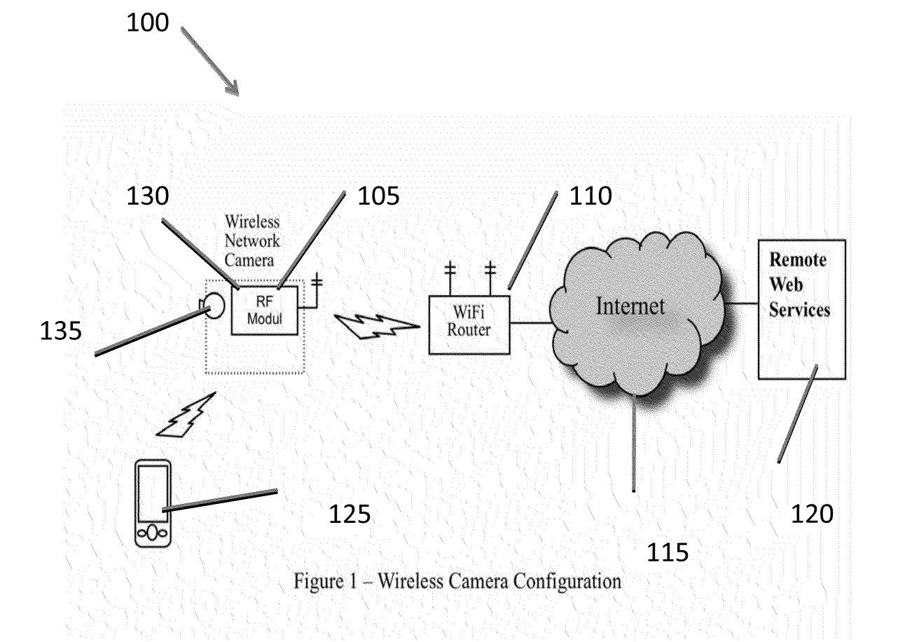

FIG. 1 illustrates a system 100 that includes a camera 105 that includes an RF module 130 and an image sensor 135. The camera 105 wirelessly connects to a router 110 that is connected to the Internet 115, which connects to an Internet server 120. A second device 125 is also shown that may connect to the Internet and receive and exchange data with the server 120. The second device 125 may connect to a hotspot formed by the wireless camera 105 and RF module 130. The camera 105 includes a Wi-Fi Setup Mode to other devices and which allows the setup process to be done all wirelessly using a single network adapter. The camera 105 forms a wireless hotspot. The hotspot is a site that offers Internet access over a wireless local area network through the use of a router connected to a link to an Internet service provider. Hotspots typically use Wi-Fi technology.

First, the user may enable a Wi-Fi setup mode on the camera 105. In the Wi-Fi Setup mode, the camera 105 creates a wireless network, allowing the user to connect wirelessly direct to the camera 105 from their computing device 125 (e.g. a Smartphone, a tablet, or a computer) all without the need of another external network. Once the user device 125 is connected to the RF module 130 of the camera 105, the user can view the camera 105 directly and configure its settings.

The camera 105 Wi-Fi setup mode also allows the camera 105 to be configured by the user to connect to another existing wireless network simultaneously, and route the Internet connection 115 to the user on their computing device 125. The camera 105 is connected to a network and verifies that connection for the user. In one embodiment, once the connection is configured, then an automatic network verification for the integrity of the connected wireless network is performed. A processor may perform a diagnostic. Diagnostic includes one or more operations including Internet connectivity, wireless signal strength, network bandwidth and throughput. In the event, the diagnostic fails then the processor may output a notification to the user. Thereafter, once the network is verified, the camera 105 is registered with a remote server 120 to the user. Once the configuration is completed, the user disables the Wi-Fi Setup mode and the camera 105 serves as a Wi-Fi client.

The camera 105 is preferably a digital camera (or digicam) that takes video or still photographs, or both, digitally by recording images via an electronic image sensor. The camera 105 may display images on a screen immediately after they are recorded, storing thousands of images on a single small memory device, and deleting images to free storage space. The camera 105 can record moving video with sound as well as still photographs. The camera 105 can crop and stitch pictures and performs other elementary image editing. The camera 105 may include a GPS receiver built in, and can produce Geotagged photographs.

The optical system works the same as in film cameras, typically using a lens with a variable diaphragm to focus light onto an image pickup device. The diaphragm and shutter admit the correct amount of light to the imager, just as with film but the image pickup device is electronic rather than chemical. The camera 105 can include a standard tripod screw.

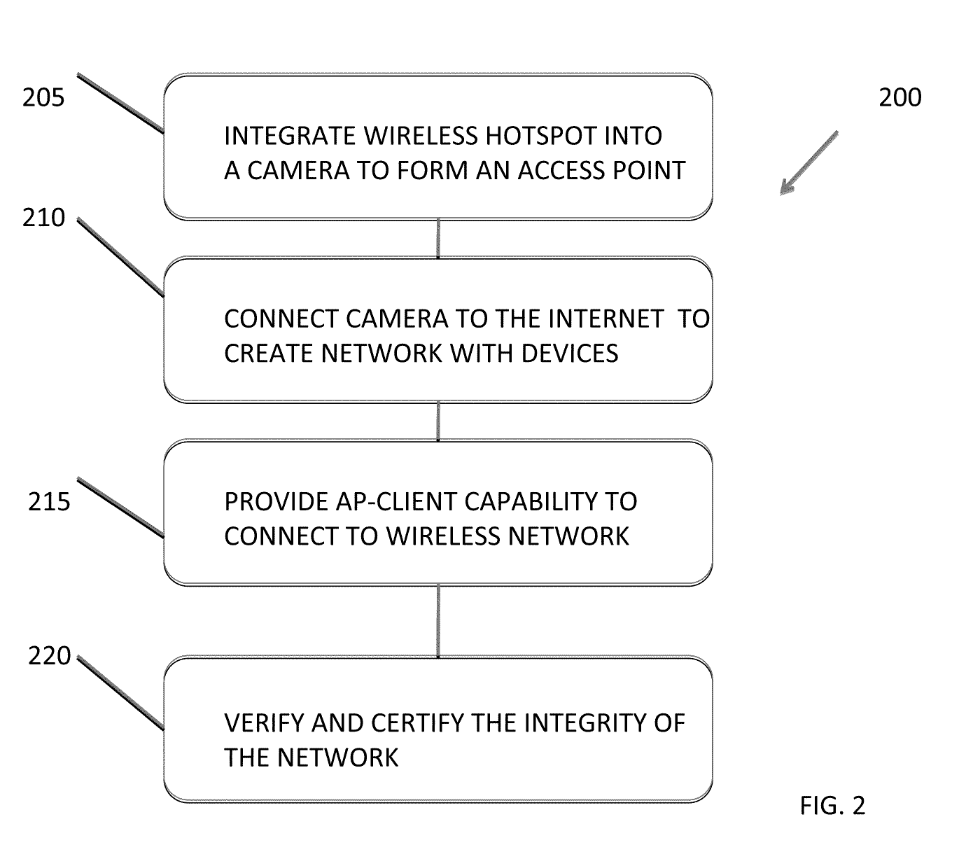

Turning now to FIG. 2, which shows a method 200. The method 200 is operable with a computing device including a processor with processor-executable instructions to perform the operations of the method 200.

In block 205, the method 200 includes the step of forming a wireless hotspot (access point) feature into the camera for other devices to connect to the RF module and to the Internet. The method 200 also includes the step of routing capability into the camera to create its own network with connected devices in block 210. The method 200 also includes the step of providing an AP-client capability into the camera so it can simultaneously connect to another wireless network in block 215. In method 200, the step also includes the step of forming a network diagnostic engine to verify and certify the integrity of the network in block 220.

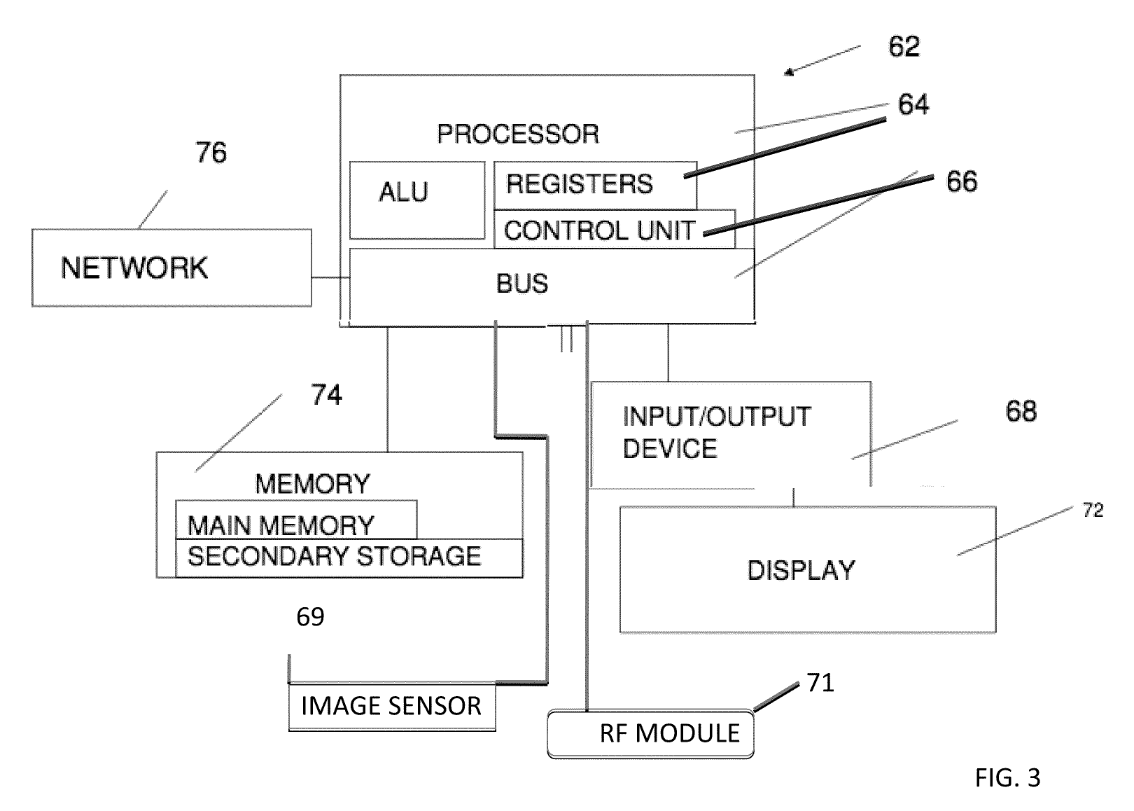

Turning now to FIG. 3, which shows a high level schematic view of the camera 300 that includes an image sensor 69 and a RF module 71, which are connected to a bus 66. Through the RF module 71, the bus is connected to a network 76. The camera 300 also includes a processor 62 including an ALU unit, registers and a control unit 64 and 66. The camera 300 also includes a memory 74 that includes a main memory and a secondary storage. The camera 300 also includes an input device 68 and a display 72.

Camera 300 includes a data modem to form a wireless access point connecting a camera 300 to the Internet (or alternatively some proprietary network). In this use the camera 300 is providing a gateway between the service provider's data network technology and Point-to-Point Protocol (PPP). In one embodiment, the camera 300 may support the Hayes command set, a standard method of controlling modems. To the network, the camera 300 appears like an external modem. Wireless FireWire, USB and Serial modems may also be utilized by the camera 300 in the Wi-Fi and WiMAX standards, operating at microwave frequencies, to give the camera 300 an access point to a network. The modem for the camera may be as small as a dongle or USB-stick. If combined with Voice over IP (VoIP) technology, camera 300 can make and receive telephone calls. In another embodiment, the camera 300 may utilize a PCMCIA, Express Card or a Compact Flash modems. The camera 300 may also include a card-modems that includes GPS. The camera 300 also may include a device that forwards data packets between computer networks, creating an overlay internetwork. The camera 300 acts as a wireless router that is connected to two or more data lines from different networks. When data comes in on one of the lines, the router reads the address information in the packet to determine its ultimate destination. Then, using information in its routing table or routing policy, it directs the packet to the next network on its journey. Router of the camera 300 may perform the “traffic directing” functions. A data packet is typically forwarded from one router to another through the networks that constitute the internetwork until it gets to its destination node, which may include a routing configuration from the Smartphone to the camera and to the Internet.

The camera 300 may utilize pure Internet Protocol (IP) forwarding function. The camera 300 is designed to minimize the state information associated with individual packets. The main purpose of a camera hotspot is to connect multiple networks and forward packets destined either for its own networks or other networks. The camera hotspot may be considered a Layer 3 device because its primary forwarding decision is based on the information in the Layer 3 IP packet, specifically the destination IP address. When another router receives a packet, it searches its routing table to find the best match between the destination IP address of the packet and one of the network addresses in the routing table. Once a match is found, the packet is encapsulated in the Layer 2 data link frame for that outgoing interface. A router does not look into the actual data contents that the packet carries, but only at the layer 3 addresses to make a forwarding decision, plus optionally other information in the header for hint on, for example, QoS. Once a packet is forwarded, the camera hotspot does not retain any historical information about the packet, but the forwarding action can be collected into the statistical data. The camera 300 may comprise a switch which allows the wireless camera to operates in at least two modes including the hotspot mode and Wi-Fi host mode. Forwarding decisions can involve decisions at layers other than layer 3. A function that forwards based on layer 2 information is called a bridge. This function is referred to as layer 2 bridging, as the addresses it uses to forward the traffic are layer 2 addresses (e.g. MAC addresses on Ethernet).

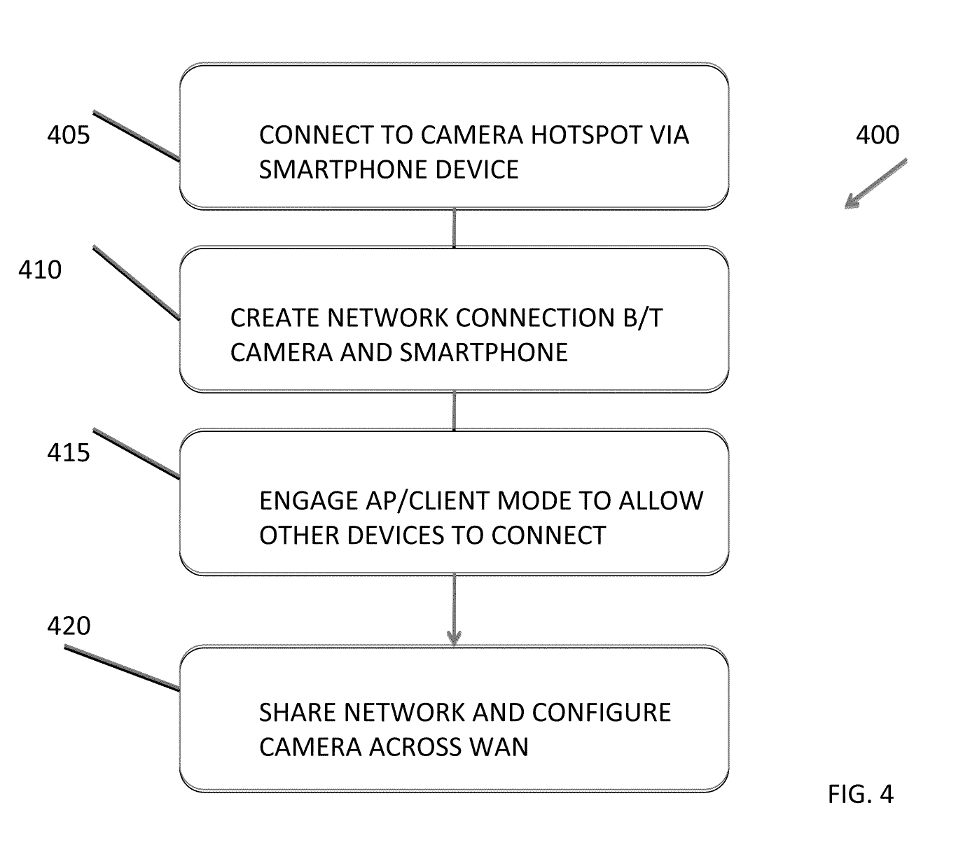

Turning now to FIG. 4which shows a method 400 of the wireless hotspot feature allowing a user to connect directly and wirelessly to the camera via a Smartphone or a computer in block 405. With the routing features, the camera can create its own wireless local network with the user's device in block 410. With the AP-Client mode feature, the user can then configure the camera to simultaneously connect to another existing wireless network (with Internet connection or WAN) and share that WAN connection with its own network in block 415. This then allows the user to configure (and verify) the camera to work with additional web services across the WAN in block 420.

The instant camera 300 provides an easier and more robust step up configuration. With the camera 300 being without the need of a cable, which requires proximity to the router, the user can now set up the camera 300 where they plan to place the camera 300. This means that the camera 300 can also warn the user if the user places the camera on the edge of the wireless network, by providing an indicator alarm, which will result in poor camera performance. The camera 300 also includes less complex operation. Unlike the traditional approach that requires a switch between two network adapters (Ethernet and Wi-Fi) in the setup process. It will usually end up with two different IP addresses. The wireless approach uses only a wireless network adapter in the entire process. It means less user confusion and less point of failure. The camera 300 also includes an easier deployment flexibility. Since no physical access to the wireless router is required, users can deploy the camera 300 on a wider range or wireless network, even when they can't physically access the wireless router hardware. Most wireless camera users do not use an Ethernet connection. This method will allow manufacturers to eliminate the Ethernet network adaptor and jack which will reduce both cost and form factor of their wireless cameras.

The camera hotspot may authenticate users. This secures the data transmission or prevents the packet sniffing (which may allow people to see traffic on the network). The camera hotspot may provide a download option that deploys WPA support. This conflicts with enterprise configurations at large enterprises that have solutions specific to their internal WLAN. A “poisoned/rogue hotspot” refers to a free public hotspot set up by identity thieves or other malicious individuals for the purpose of “sniffing” the data sent by the user and may be connected within the camera 300. Such identity thieves will have access to the MAC address of the connecting terminal, which individually identifies the hardware. By examining packets sent, they may attempt to decipher passwords, login names, or other sensitive information. The camera hotspot may utilize a hotspot program, which aims to encrypt hotspot traffic with the latest WPA2 security.

While this invention has been particularly shown and described with references to a preferred embodiment thereof, it will be understood by those skilled in the art that is made therein without departing from the spirit and scope of the invention as defined by the following claims.

What is claimed is:

1. A method of linking to a network, comprising:
providing a camera that includes an RF device;
linking the RF device to a wireless router;
linking the wireless router to the Internet; and
linking to the RF device to link to the Internet.

2. The method of claim 1, further comprising capturing digital images from the camera.

3. The method of claim 1, further comprising forming a wireless hotspot so a second device can link to the Internet via the RF device.

4. The method of claim 3, further comprising actuating an input to enable a Wi-Fi Setup mode.

5. The method of claim 4, further comprising forming a wireless network, allowing the RF device to connect wirelessly direct to the RF device from the second device.

6. The method of claim 5, further comprising controlling the camera from the second device to control the camera directly and configure settings.

7. The method of claim 6, further comprising the RF device connecting to an existing wireless network and routing an Internet connection to the second device.

8. The method of claim 7, further comprising connecting the camera to a network and verifying a network connection.

9. The method of claim 8, further comprising conducting an automatic network verification for an integrity of the connected wireless network.

10. The method of claim 9, further comprising performing a diagnostic that includes at least one of Internet connectivity, wireless signal strength, network bandwidth and throughput.

11. The method of claim 10, further comprising registering the camera with a remote server.

12. The method of claim 11, further comprising disables the Wi-Fi Setup mode and the camera serves as a Wi-Fi client.

13. The method of claim 1, wherein the camera comprises an image sensor.

14. The method of claim 1, wherein the camera captures digital video.

15. The method of claim 1, wherein the RF device comprises a wireless transmitter and receiver.

16. The method of claim 1, further comprising: linking a plurality of computer devices to the RF device to connect to a server.

17. A wireless camera, comprising:
an image sensor;
a processor;
a memory coupled to the processor;
an RF device, wherein the RF device links to a wireless router connected to the Internet; and
the RF device adapted to form a wireless hotspot so a plurality of second devices can connect to the Internet via the wireless camera.

18. The wireless camera of claim 17, wherein the image sensor captures digital images.

19. The wireless camera of claim 17, further comprising a second device linking to the Internet via the RF device.

20. The wireless camera of claim 17, further comprising an input device for actuating an input to enable a Wi-Fi Setup mode.

21. The wireless camera of claim 17, further comprising
controlling the camera from a second device to control the camera directly and to configure camera settings.

22. The wireless camera of claim 17, wherein the RF device connects to an existing wireless network and routes an Internet connection to the second device.

23. The wireless camera of claim 17, further comprising connecting the camera to a network and verifying a network connection.

24. The wireless camera of claim 17, further comprising conducting an automatic network verification for an integrity of the connected wireless network.

25. The wireless camera of claim 16, further comprising performing a diagnostic that includes at least one of Internet connectivity, wireless signal strength, network bandwidth and throughput.

26. The wireless camera of claim 17, further comprising registering the camera with a remote server.

27. The wireless camera of claim 17, further comprising disabling the Wi-Fi Setup mode and the camera serving as a Wi-Fi client.

28. The wireless camera of claim 17, wherein the camera captures digital video.

29. The wireless camera of claim 17, wherein the RF device comprises a wireless transmitter and receiver.

30. The wireless camera of claim 17, further comprising: linking the plurality of computer devices to the RF device to connect to a server.

31. A camera, comprising:
a module in which a user can connect wirelessly directly to the camera via a wireless hotspot formed by an RF module to view and configure the camera.

32. The camera of claim 31, further comprising:
a dual mode wireless camera that can be both a Wi-Fi mode as well as a Wi-Fi hotspot mode.

33. The camera of claim 32, further comprising:
a switch which allows the wireless camera to operates in at least two modes.

34. The camera of claim 33, wherein when switching on the hotspot mode a second communication device connect directly via Wi-Fi to the camera from the second communication device to view the camera and to configure the camera.

35. The camera of claim 34, wherein when switching off the hotspot mode the camera operates in the Wi-Fi mode.
